(19) United States
(12) Patent Application Publication
(10) Pub. No.: US 2018/0332867 A1
(43) Pub. Date: Nov. 22, 2018

(54) DAIRY SPREAD COMPOSITION AND METHOD FOR ITS PRODUCTION

(71) Applicant: DMK, Deutsches Milchkontor GmbH, Zeven (DE)

(72) Inventors: Uwe Wärner, Elsdorf (DE); Peter Stampe, Westerstede (DE)

(21) Appl. No.: 15/947,348

(22) Filed: Apr. 6, 2018

(30) Foreign Application Priority Data
May 18, 2017 (EP) 17 171 647.5

(51) Int. Cl. A23C 15/06; A23C 15/12; A23L 35/00

(52) U.S. Cl. CPC A23C 15/06; A23C 15/12; A23L 35/10; A23C 2240/05; A23C 2260/104; A23V 2300/38; A23V 2250/21; A23V 2300/24; A23V 2300/26; A23V 2300/31; A23V 2002/00

(57) ABSTRACT

A dairy spread composition is suggested, obtained or obtainable by:
(a) providing a cream fraction having a content of at least 40% by weight fat and at least 6% by weight fat-free dry matter;
(b) subjecting the cream fraction to a temperature ripening step;
(c) churning the ripened cream fraction, and separating the buttermilk;
(d) adding salt and an acidification permeate to the butter such obtained;
(e) mixing the acidified at 12 to 16° C. with a vegetable fat that is liquid at this temperature;
(f) adding an aqueous phase to the blend in small doses, and
(g) packaging the blend after homogenisation and cooling.

### FIELD OF THE INVENTION

The invention is in the field of butter technology and relates to improved dairy spread compositions, an improved method of production thereof, and use of the products.

### STATE OF THE ART

Fats, which are used for nutrition purposes and which remain solid at room temperature but are still spreadable, are referred to as spreadable fats. Examples are butter or margarine, but also vegetable fats. From a chemical standpoint, spreadable fats are solid, plastic emulsions with fat as an essential component. All spreadable fats must be suitable for human consumption.

According to the definition of the European Commission, spreadable fats are “Products with a fat content of at least 10% but less than 90% by weight and which remain solid at a temperature of 20 C.”

In contrast to this, according to this Regulation, “the terms ‘butter’ and ‘margarine’ are only used for products with a fat content of not less than 80%”. Through this, it is intended to protect the consumer against any possible confusion between butter, margarine and other spreadable fats with a differing fat content (e.g., Minarine). According to Council Regulation (EC) 2991/94, spreadable fats are classified into the following three groups:
Milk fats: These are exclusively produced on the basis of milk or particular dairy products. These include the following: butter, three-quarter-fat butter, half-fat butter and dairy spread.
Fats: These are obtained from solid or liquid vegetable lipids or animal lipids (animal fat). They contain at most 3% dairy fat. The products are referred to as: margarine, three-quarter-fat margarine, half-fat margarine, spreadable fat. Fats that are referred to as vegetable fats may contain at most 2% fat of animal origin.
Blends: These are derived from solid or liquid vegetable or animal products, i.e. mixtures of those. In blends, the milk fat content may amount to between 10% and 80% of the total fat content. The products are sold as blends, three-quarter-fat blend, half-fat blend, or blended spread.

In the past years, spreadable fat compositions having both milk fat portions and vegetable fat portions established themselves firmly in addition to butter and margarine, as they are spreadable just like margarine when taken out of the refrigerator but have a taste that is more reminiscent of butter.

Products are known from the state of the art, according to which dairy spread compositions of this type are obtainable from blends, for example, EP 1279338 A, WO 1999 043218 A1, WO 1999 051105 A1, U.S. Pat. No. 4,298,625, or U.S. Pat. No. 6,136,349.

DK 171699 B1 discloses a process for the production of a spreadable fat. The mass includes a phase, containing 80 to 83% by weight vegetable oil, water, and salt, wherein one part of which is continuously kneaded into a butter phase and the other one is added at the end of the process.

Specifically, EP 1688044 B1 (DRAGSBAEK) suggests a process wherein three streams of components are combined: in the first one, a vegetable oil blend of rapeseed oil and palm oil, which had been homogenized by heating, is cooled down and mixed with a butter, the crystal structure of which must be mechanically broken to make it pumpable. The flavour component, which consists of an aqueous mixture of skimmed milk powder and salt, is added in doses by means of a third pump. Blending is performed in a crystallizer, the result is subsequently processed to obtain a finished spreadable fat, in the process of which lactic acid bacteria are added as a further mandatory component in order to adjust the acid content and, therefore, the taste of the product. This process has a number of considerable disadvantages: the blend of rapeseed oil and palm kernel oil must be liquefied by heating it firstly. Subsequently, the blend is cooled and crystallized and blended with a butter phase which, however, is present in crystalline form; therefore, its crystal structure will have to be broken, requiring a high input of energy, to make it pumpable and dosable. In addition, the resulting product is not sufficiently homogeneous so that an emulsifier is required; to this end, skimmed milk powder is added to the blend. As a result, the process appears to be technically complex, involving high costs of energy. There is also room for improvement with respect to taste and spreadability.

The object of the present invention was therefore to improve the state of the art such that both any mechanical breaking of the crystal structure of the milk fat portion and the co-use of food emulsifiers can be omitted. At the same time, it was intended to improve both the spreadability and the taste profile of the products.

### DESCRIPTION OF THE INVENTION

A first subject matter of the invention relates to a dairy spread composition, obtainable or obtained by:
(a) providing a cream fraction having a content of at least 40% by weight fat and a fat-free dry matter of at least 6% by weight;
(b) subjecting the cream fraction to a temperature-ripening step, preferably at 12 to 14° C.;
(c) churning the ripened cream fraction, and separating the buttermilk
(d) adding salt and an acidification permeate to the butter such obtained;
(e) blending the acidified butter at 12 to 16° C. with a vegetable fat that is liquid at this temperature;
(f) adding an aqueous phase to the blend, and
(g) packaging the blend after homogenisation and cooling.

The particular advantage of the process of the invention is that the precise temperature control allows that milk fats are obtained in the cream ripening step on the one hand and after the churning step on the other, which are only insufficiently crystallized and are still pumpable and conveyable as a result. In this manner, any input of mechanical energy is avoided, saving the associated high cost. In addition, the co-use of skimmed milk powders is no longer required, as the masses are sufficiently homogeneous, not requiring any emulsifiers. Using an acidification permeate already in the churning step assists in obtaining a dairy spread composition with a significantly more buttery taste profile. In total, the products are also characterised by a better spreadability, particularly at a temperature of 5 to 8° C.

The compositions of the invention, preferably, contain at least 40 (“low fat”) or 75% by weight fat, particularly 76 to 82% by weight fat. Based on the fat phase, they further contain, preferably, 40 to 60% by weight dairy fat and specifically about 50% by weight vegetable fat, ad 100% by weight in each case. Further, it is preferred that they contain at least 70% by weight fat, and particularly at least 80% by weight fat, which is solid at 20° C., based on the fat content.

Method of Production

A further subject matter of the invention relates to a process for the production of a dairy spread composition, comprising or consisting of a sequence of the following steps:
(a) providing a cream fraction having a content of at least 40% by weight fat and at least 6% by weight fat-free dry matter;
(b) temperature ripening of the cream fraction, preferably, at 12 to 14° C.;
(c) churning of the ripened cream fraction, and separation of the buttermilk;
(d) adding salt and an acidification permeate to the butter such obtained;
(e) blending the acidified butter at 14 to 16° C. with a vegetable fat that is liquid at this temperature;
(f) adding an aqueous phase in small doses, and
(g) homogenising, cooling and packaging of the blend.

### BRIEF DESCRIPTION OF THE DRAWING

The invention will be described in greater detail with reference to the accompanying drawings which illustrates a flow chart for preparing the dairy spread composition.

Cream Ripening

Cream fractions of the type mentioned are typically obtained during the skimming of raw milk. The following heat treatment, referred to as “cream ripening”, is decisive for this process. Cream ripening serves to intensively prepare the cream for the churning process, which distinguishes a physical and a biochemical cream ripening step.

In the present physical cream ripening step, the cream fraction of a temperature of about 50° C. is cooled down to a temperature of 11 to 15° C. after exiting the separator and is maintained at this temperature for about 6 to about 18 hours, preferably, about 10 to about 15 hours. Preferably, during the cream ripening step it is recommended to proceed according to the method of cold/warm/cold ripening. Cold/warm/cold ripening offers the greatest possible influence on the butter consistency to be achieved. In doing so, the cream is heated to temperatures of about 20° C. for multiple short periods and is then cooled.

Cream ripening influences the following criteria
consistency, firmness, spreadability
basic water content of the butter (longer shelf life)
fat content of the buttermilk
acidification, formation of aroma
butter yield

In the process of cream ripening, four different types of fat globules are formed:

Type 1: Fat globules having a thin peripheral crystal layer and a liquid core.
Type 2: Fat globules having a thin peripheral crystal layer and a core, containing crystalline agglomerates and little liquid fat
Type 3: Fat globules having thick crystalline shells and a liquid core
Type 4: Fat globules having thick crystalline shells and a core containing crystalline agglomerates and little liquid fat.

Churning

The ripened cream fraction is subsequently churned in a conventional manner, i.e., the cream is agitated, damaging the fat globules of the milk fat. The fat membrane breaks open, the contained fat leaks out, and the fat globules agglutinate. In doing so, parts of the fat membranes, water, and some milk protein are enclosed. The liquid fat-in-water emulsion becomes a solid water-in-fat emulsion. The by far largest of these fat-free components (whey) leaks out as buttermilk and is separated. What is left is a butter, typically containing 82% by weight fat, 2% by weight fat-free dry matter 16% by weight water.

Another essential aspect of the invention is that the butter such obtained is further processed directly after the churning step, maintaining the temperature at 14 to 16° C. in the process. Under these conditions, the butter is only partly crystallized and is therefore still plastically formable, so that only a stirring tank reactor, or a homogenizer, is required to admix the other components. In contrast with the use of finished butter, which is stored in cold storage and which is fully crystallized, the mechanical breaking of the crystal structure is avoided, thus saving time and energy.

Acidification

Subsequently, salt and an acidification permeate are added to the resulting butter. This step is required to give the dairy spread composition a buttery taste. Surprisingly, the process showed that an acidification at this stage using an acidification permeate leads to a better taste evaluation than does the addition of lactic acid cultures to the finished product, as is known for the acidification process from the state of the art.

The production of an acidification permeate, for example, is described in DE 2652558 C3 (STICHTING). According to this disclosure, the acidification process for producing aroma substances is best performed with skimmed milk using microorganisms which produce aroma-forming substances, particularly, diacetyl and α-acetyl lactic acid. To this end, those starters are suited best which contain Leuconostoc cremoris (the so-called B starters), and particularly those which contain particular strains of Streptococcus diacetilactis (the so-called D-starters) and mixtures thereof (BD starters). Acid or sweet whey, fractions thereof obtained according to physical separation methods or from skimmed milk, and other known culture media are also suitable to incubate aroma-forming bacteria. The incubation of lactic acid bacteria (lactic acid starters) in liquids based on whey is known from NL-OS 72 05 909. It is also known that keeping the culture in motion increases the diacetyl content in those aromatic starters. In doing so, oxidation induces a conversion of α-acetyl lactic acid into diacetyl. However, it was shown that a much stronger formation of diacetyl is obtained during the ripening process of the butter after kneading starters, which were kept in motion, into butter solids or into butter obtained by churning non-acidified cream, than is obtained in the case of butter obtained by churning sour cream, or in the case of butter obtained from sweet cream, which had been acidified by adding a solution of chemically pure lactic acid. Therefore, the distribution of moisture, which is achieved by kneading the butter until dry, is of importance. The coarser it is, the more diacetyl is subsequently formed, and depending on this, more or less powerful aroma-forming starters or mixtures thereof will be used.

The aromatic starters may be kneaded in as they are, but also after removing the protein, in which case, firstly, a concentration of the aromatic substances according to a process known per se could have been performed. According to any of the conditions mentioned above, optionally, the aromatic starter can be used as a culture medium, namely, for lactic acid bacteria which produce a lot of lactic acid.

The acidification process for obtaining a high content of lactic acid can also be performed using skimmed milk; preferably, however, other culture media on the basis of milk are used, provided they act as sufficiently powerful buffers against the decrease of the pH value caused by the production of lactic acid, so that it won't be necessary to add any buffer-salt mixtures. Suitable culture media are sweet or sour whey obtained during the production of cheese, quark or cottage cheese, particularly the mother liquor of whey, which has been used for the production of lactose, or solutions of low-lactose whey powders obtained thereof. The two last-mentioned culture media are preferred, as they provide a ratio of whey protein content and lactose content that is favourable for obtaining a high lactic acid content and a high ratio of resulting lactic acid and unfermented lactose. In this case, the subsequent concentration step should not result in any opacity following the crystallisation of lactose.

The buffer effect of the whey protein ensures a high content of lactic acid, and the pH value will not decrease below the level where the metabolism processes of the lactic acid bacteria are coming to a standstill. In most cultures of lactic acid bacteria, this value is in the range of between 4.3 and 4.6. However, lactic acid bacteria are preferably used, as their metabolism is less sensitive to lower pH values. A particularly low sensitivity to high acidity is found in Lactobacillus helveticus which still thrives at pH values of below 3.3.

High lactic acid contents, e.g., of 20 to 25 g/l are obtained with this particular species, particularly in well-buffered culture media. This percentage can be increased even more by applying known concentration methods. Further, it is particularly advantageous to separate the culture into a high-protein retentate and a low-protein permeate by means of ultrafiltration before concentration, particularly when a low-lactose culture is used. The permeate, again, can be concentrated by means of vacuum evaporation or membrane filtration (reverse osmosis) and, optionally, subsequent evaporation. In this manner, the ratio of whey protein to lactic acid can be considerably reduced, e. g, from 0.20 in the Lactobacillus helveticus starter to 0.12 in the permeate and less than 0.07 in the permeate from the reverse osmosis step. If said last-mentioned permeate is evaporated it is quite easy to obtain a lactic acid content of more than 35% by weight.

Only very small amounts of these strongly acid and comparably low-buffered lactic acid solutions are used to reduce the pH value of the butter serum to below 5.3, after kneading them into butter that was made from non-acidified cream. PH values of 4.0 may be obtained using 1% by weight of this concentrate and 1% by weight of an aromatic starter. Frequently, the required decreased pH value can be obtained using a concentrate of at most 0.5% by weight.

In order to obtain the above mentioned high lactic acid content, it is recommended to strongly evaporate the permeate, thus avoiding a crystallisation of the lactose. Therefore, the culture medium used to incubate the lactic acid bacteria should, preferably, have a low content of lactose (low-lactose whey). For clarity, it is pointed out that the acidification permeate thus obtained does not contain any living bacteria cultures.

The amount of salt to be added to the ripened cream fraction is typically within the range of 0.1 to about 4% by weight, preferably, of 0.5 to 2% by weight. The acidification permeate is normally added in amounts such that a pH value of about 4.0 to about 6.0 and, particularly, about 4.2 to about 5.0 is obtained.

Addition of the Vegetable Fat

Suitable vegetable fats to be added to the butter mass are liquid and are typically selected from the group consisting of palm oil, rapeseed oil according to historic and modern cultivation, safflower oil, olive oil, sunflower oil, linseed oil and blends thereof. In this context it is problematic that, for example, palm oil has a particularly advantageous taste but it is solid at 20° C. and, therefore, must be heated in order to become pumpable. Therefore, it has proved to be advantageous to add blends of palm oil and other vegetable fats that are liquid at 20° C., i.e., vegetable oils. Considering both the melting point and taste aspects, blends of palm oil and rapeseed oil have proven to be particularly advantageous, given that blends containing up to 50% by weight palm oil are still liquid at 20° C. Typically, palm oil and rapeseed oil are used in a weight ratio of about 40:60 to about 60:40 and, particularly, about 50:50. The blend is added to the cream in doses such that, based on the fat phase, 40 to 60% by weight milk fat and ad 100% by weight vegetable fat in each case are present.

Addition of the Aqueous Phase

In principle, it is possible to add the aqueous phase in doses together with the liquid vegetable fat, but it will require the addition of an emulsifier in this case. The process according to the invention, therefore, provides for a separate addition. Normally, the amount is about 10 to 50% by weight and, preferably, about 15 to 25% by weight, based on the fat phase, i.e., the sum of milk fat and vegetable fat. Preferably, an aqueous salt solution is added, which, if needed, may also contain further components in the dissolved state, for example, water-soluble aroma substances. When the mass is sufficiently homogenised, it can be filled directly into the final packaging.

A typical dairy spread composition according to the invention is obtained by carrying out all steps below a temperature of 22° C. and, preferably, at room temperature, unless specified otherwise, having the following composition:
(a) about 30 to about 40 and, preferably, about 35% by weight milk fat;
(b) about 30 to about 40 and, preferably, about 35% by weight vegetable fat, preferably, palm oil and rapeseed oil in a weight ratio of about 40:60 to about 60:40;
(c) 0.5 to about 4, preferably, about 1 to about 2% by weight (common) salt and/or aroma substances, and
(d) ad 100% by weight water

### INDUSTRIAL APPLICABILITY

A further subject matter of the invention relates to the use of the novel spreadable fats as foods, specifically, as a butter substitute.

### EXAMPLES

### Example 1

Raw milk was supplied to a separator and separated into a skimmed milk fraction and a cream fraction. The cream fraction had a fat content of 40% by weight and 6% by weight fat-free dry matter. The fraction was cooled down from about 50° C. to 12° C., after leaving the separator, and was maintained at this temperature for 12 hours, wherein it was heated to 20° C. for a period of about 3 hours in the meantime. After the end of the ripening step, the fraction was crystallised to 62% by weight, still remaining plastic and formable. The ripened cream fraction was supplied to a churning machine and agitated until solid. The raw butter was easily kneadable, was repeatedly washed with water, and 2% by weight sodium chloride and such amount of an acidification permeate were added to it such that a pH value of 4.8 was obtained. Subsequently, the acidified butter was supplied into a mixer at 14° C., where the same amount of a liquid blend of 60% by weight rapeseed oil and 40% by weight palm oil, which had been pre-heated to room temperature, was added to it. Simultaneously, an 1% by weight aqueous solution of sodium chloride was added in an amount that corresponded to about 15% by weight to the fat mass. The mass was homogenised and subsequently filled into sterile containers and packaged.

### Comparison Example V1

In analogy to EP 1688044 B1, 50% by weight butter, which had been plasticised by introduction of mechanical energy before, 25% by weight of a blend of rapeseed oil and palm oil (60:40) and 25% by weight of an aqueous phase, containing 14% by weight skimmed milk powder, 3% by weight sodium chloride, 5% by weight lactic acid bacteria and ad 100% by weight water were placed into a mixing device at 20° C. and homogenised at 20° C. for a period of 60 minutes. Subsequently, the mass was filled into sterile containers and packaged.

Evaluation of the Two Products

Both products were stored at 5° C. for a period of 3 hours, and 5 testers evaluated both the spreadability and the taste thereof directly after removal (from cold storage) on the one hand, and after 10 minutes storage at room temperature on the other, on a scale of (1)=solid to (5)=oily, or (1)=buttery to (5)=low-flavour. The results are summarised in Table 1, indicating average values.

TABLE 1
Evaluation of the spreadable fats

| Products according to example | 1 | V1 |
|---|---|---|
| Spreadability, directly after removal from cold storage | 4 | 3 |
| Spreadability after 10 minutes | 4 | 5 |
| Taste | 2 | 3 |

The composition of the invention showed a good spreadability at all times while the comparison product left a more solid impression, but becoming significantly softer after 10 minutes, leaking oil droplets in the process. In addition, the product of the invention was also evaluated as significantly “more buttery”.

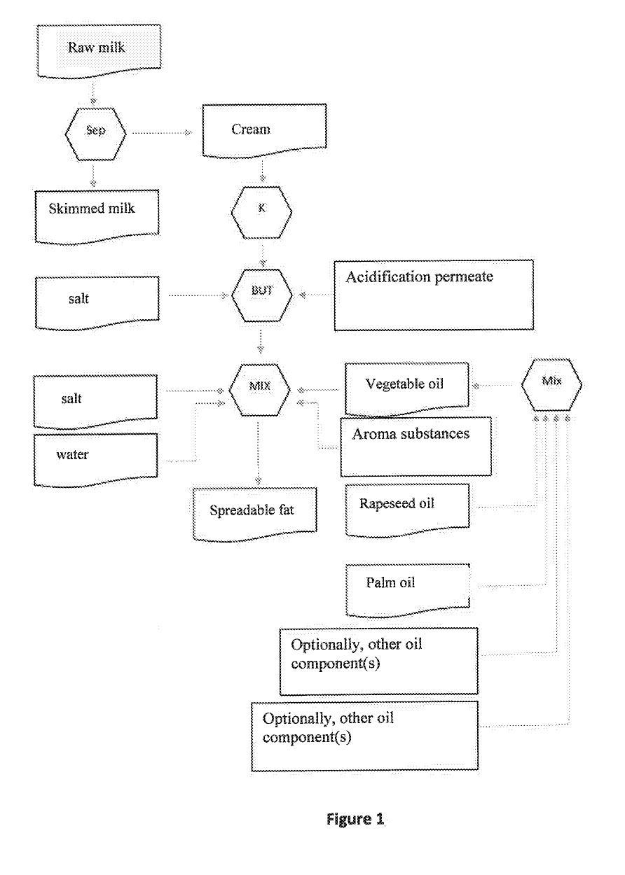

The invention is explained in the following flow chart by way of example (FIG. 1). The abbreviations have the following meanings:

SEP=separator
K=cooler
MIX=mixer
BUT=churning (of the butter)

1. A dairy spread composition, obtained by:
(a) providing a cream fraction having a content of at least 40% by weight fat and at least 6% by weight fat-free dry matter;
(b) subjecting the cream fraction to a temperature ripening step;
(c) churning the ripened cream fraction, and separating the buttermilk;
(d) adding salt and an acidification permeate to the butter such obtained;
(e) blending the acidified butter at 12 to 16° C. with a vegetable fat that is liquid at this temperature;
(f) adding an aqueous phase to said blend; and
(g) packaging the blend after homogenisation and cooling.

2. The composition of claim 1, containing at least 75% by weight fat.

3. The composition of claim 1, containing 40 to 60% by weight milk fat and ad 100% by weight vegetable fat in each case, based on the fat phase.

4. The composition of claim 1, containing at least 70% by weight fat, which is present in solid form at 20° C., based on the fat phase.

5. A method for the preparation of a dairy spread composition, comprising the sequence of the following steps:
(a) providing a cream fraction having a content of at least 40% by weight fat and at least 6% by weight fat-free dry matter;
(b) temperature ripening of the cream fraction;
(c) churning of the ripened cream fraction and separation of the buttermilk;
(d) adding salt and an acidification permeate to the butter such obtained;
(e) blending of the acidified butter at 12 to 16° C. with a vegetable fat that is liquid at this temperature;
(f) adding an aqueous phase to this blend; and
(g) homogenisation, cooling and packaging of the blend.

6. The method of claim 5, wherein ripening is performed for a period of 6 to 18 hours.

7. The method of claim 5, wherein 0.1 to 4% by weight salt is added to the butter.

8. The method of claim 5, wherein an amount of acidification permeate is added to the butter such that a pH value of about 4.0 to 6.0 is obtained.

9. The method of claim 5, wherein a liquid vegetable fat selected from the group consisting of palm oil, rapeseed oil according to historic and modern cultivation, safflower oil, olive oil, sunflower oil, linseed oil and blends thereof is added to the butter.

10. The method of claim 9, wherein a blend of palm oil and rapeseed oil is used.

11. The method of claim 10, wherein a blend of palm oil and rapeseed oil in a weight ratio of about 40:60 to about 60:40 is used.

12. The method of claim 5, wherein a blend is produced which contains 40 to 60% by weight milk fat and ad 100% by weight vegetable fat in each case, based on the fat phase.

13. The method of claim 5, wherein about 10 to 50% by weight of the aqueous phase is added to the fat phase.

14. The method of claim 5, wherein an aqueous phase is added that contains salts and/or aroma substances.

15. A butter substitute comprising the dairy spread composition of claim 1.
